(19) United States
(12) Patent Application Publication
(10) Pub. No.: US 2017/0208465 A1
(43) Pub. Date: Jul. 20, 2017

(54) COMMUNICATION APPARATUS, METHOD OF SHARING COMMUNICATION PARAMETERS, AND PROGRAM

(71) Applicant: CANON KABUSHIKI KAISHA, Tokyo (JP)

(72) Inventor: Tsuyoshi Terao, Yokohama-shi (JP)

(21) Appl. No.: 15/404,847

(22) Filed: Jan. 12, 2017

(30) Foreign Application Priority Data
Jan. 18, 2016 (JP) 2016-007426

(51) Int. Cl. H04W 12/06; H04L 9/08; H04L 29/06; H04L 12/24; H04L 29/08

(52) U.S. Cl. CPC H04W 12/06; H04L 41/0803; H04L 67/34; H04L 63/062; H04L 63/0428; H04L 9/0841

(57) ABSTRACT

When information for setting communication parameters includes predetermined information, a communication apparatus performs an authentication process involving wireless communication of authentication information generated using random information and information for use in the authentication process included in the information for setting the communication parameters. When the information for setting communication parameters does not include the predetermined information, the communication apparatus performs an authentication process involving wireless communication of authentication information generated using information for use in the authentication process and without using the random information.

### BACKGROUND

Field

The present disclosure relates to an apparatus that communicates communication parameters.

Description of the Related Art

In order for a communication apparatus to communicate by a connection to a wireless network, it is necessary to set various communication parameters, such as encryption method, encryption key, and authentication method. Japanese Patent Laid-Open No. 2014-60623 discloses a technique for facilitating setting of these communication parameters. According to Japanese Patent Laid-Open No. 2014-60623, the communication apparatus displays a QR code® including information on the communication parameters. The QR code® is imaged and read, and the read communication parameters are set in an access point.

### SUMMARY

A communication apparatus includes an acquisition unit that acquires information for setting wireless communication parameters, a first generation unit that generates authentication information using random information randomly set and information for use in an authentication process included in the acquired information, a second generation unit that generates authentication information using the information for use in the authentication process included in the acquired information and without using the random information, an authentication unit that, when the acquired information includes predetermined information indicating that the authentication process is to be performed using the authentication information generated using the random information, performs the authentication process involving wireless communication of the authentication information generated by the first generation unit with another communication apparatus, and when the acquired information does not include the predetermined information, performs the authentication process involving wireless communication of the authentication information generated by the second generation unit with the another communication apparatus, and a setting unit that, when authentication succeeds, sets the wireless communication parameters to the another communication apparatus with which the wireless communication has been performed in the authentication process.

Further features will become apparent from the following description of exemplary embodiments (with reference to the attached drawings).

### BRIEF DESCRIPTION OF THE DRAWINGS

FIG. 1 is a diagram illustrating a hardware configuration of a communication apparatus.

FIG. 2 is a diagram illustrating a software configuration of the communication apparatus operating as a providing apparatus.

FIG. 3 is a diagram illustrating a software configuration of the communication apparatus operating as a reception apparatus.

FIG. 4 is a diagram illustrating a configuration of a communication system.

FIG. 5 is a flowchart of operations of a smart phone.

FIG. 6 is a flowchart of operations of a camera.

FIG. 7 is a flowchart of operations of a printer.

FIG. 8 is a sequence chart of the communication system.

FIG. 9 is a sequence chart of the communication system.

### DESCRIPTION OF THE EMBODIMENTS

It is contemplated that authentication information is included in code information such as a QR code® to set communication parameters by imaging the code information, and when authentication between apparatuses by the use of the authentication information has succeeded, the communication parameters can be passed to improve security.

However, code information printed on labels attached to the housing of a device or packaging associated with a device cannot be changed. That is, the device corresponding to the code information can be identified from the information included in the code information printed on the label. Accordingly, to perform authentication based on the authentication information included in such unchanged code information, the device-identifiable information is sent over a wireless interface. Transmitting the device-identifiable information over a wireless interface is not preferred from a viewpoint of privacy protection because a malicious third party may be able to obtain the device-identifiable information.

To prevent the device-identifiable information to be transmitted over the wireless interface, authentication information is generated, for example, using the information included in the code information and random information randomly set.

Apparatuses that can display the code information on displays can, for example, change and dynamically display the code information. Accordingly, the authentication information included in the code information can be variable in individual processes, and the device-identifiable information is not sent over the wireless interface. However, even in the case of non-device-identifiable information, when authentication is attempted using random information to generate authentication information, the time to conduct the authentication can become long and increase the processing load.

An embodiment enables setting communication parameters with a compatibility between the protection of privacy and the prevention of unnecessary increase in the time to conduct authentication and/or unnecessary increase in processing load.

A communication apparatus according to an embodiment will be explained below in detail with reference to the drawings. In the example described below, a wireless LAN system in conformity with IEEE802.11 series is used. However, the communication mode is not limited to the wireless LAN in conformity with the IEEE802.11 series. For example, the embodiment is also applicable to communication apparatuses in conformity with other wireless communication methods such as Bluetooth®, near field communication (NFC), or ZigBee. In addition, the embodiment is also applicable to communication apparatuses in conformity with wired communication methods such as a wired LAN.

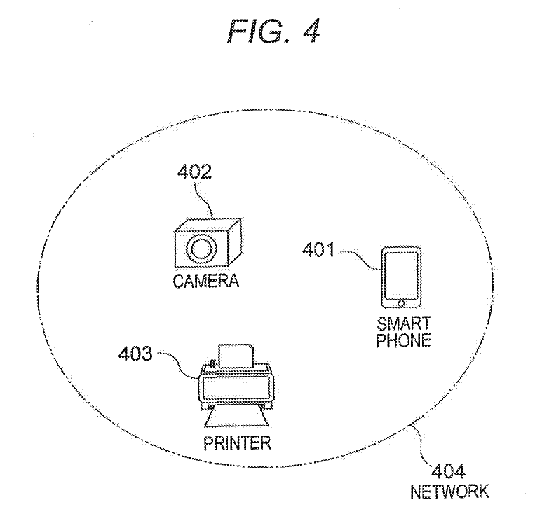

FIG. 4 is a diagram illustrating a configuration of a communication system according to the present embodiment. The communication system includes a smart phone 401, a camera 402, and a printer 403. A process in the case where the camera 402 and the printer 403 are joined in a wireless network 404 (hereinafter, called network) formed by the smart phone 401 will be explained below. The apparatuses can be other apparatuses, such as, for example, a cellular phone, a PC, a video camera, a smart watch, or a PDA. While the number of apparatuses in the present communication system is three, the number of apparatuses is not limited to three.

In the present embodiment, the smart phone 401 operates as an access point in an infrastructure mode defined in the IEEE802.11 series standards. The other apparatuses operate as stations (STA) in the infrastructure mode defined in the IEEE802.11 series standards. The network 404 can be formed by the smart phone 401 as a group owner of Wi-Fi Direct® and the camera 402 and the printer 403 as clients of Wi-Fi Direct®. The network 404 can be a network formed by an apparatus different from the smart phone 401, the camera 402, and the printer 403 as an access point (AP).

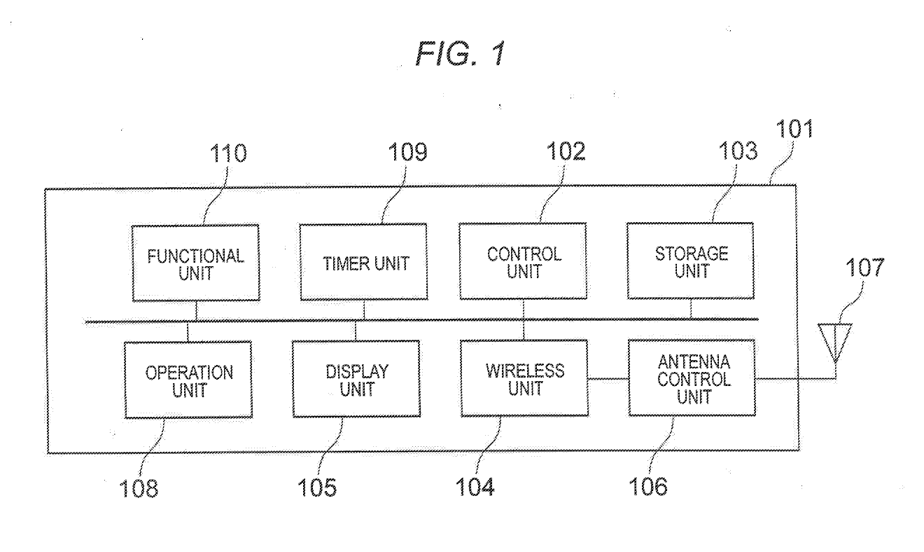

A hardware configuration of the communication apparatuses, i.e., the smart phone 401, the camera 402, and the printer 403, in the communication system of the present embodiment will be explained with reference to FIG. 1. The communication apparatus 101 includes a control unit 102, that includes a CPU or an MPU (not illustrated), which controls the communication apparatus 101 by executing programs stored in a storage unit 103. Alternatively, the control unit 102 can control the communication apparatus 101 in cooperation with an operating system (OS) executed by the control unit 102. The control unit 102 also performs a control to communicate and share communication parameters with other communication apparatuses.

The storage unit 103 includes a ROM and a RAM (not illustrated) to store programs for performing various operations described below and various kinds of information, such as wireless communication parameters. The various operations described below are performed by the control unit 102 executing control programs stored in the storage unit 103. A storage medium other than the ROM and the RAM can be used as the storage unit 103, such as a flexible disk, a hard disk, an optical disk, a magneto-optical disk, a CD-ROM, a CD-R, a magnetic tape, a non-volatile memory card, or a DVD.

A wireless unit 104 performs wireless communication via a wireless LAN in conformity with the IEEE802.11 series standards or the like. The wireless unit 104 includes, for example, a chip (not illustrated) for performing the communication. The wireless unit 104 can include hardware for performing short-range wireless communication via networks other than a wireless LAN, for example, via NFC or the like. A display unit 105 can be any type of display, for example, an LCD or an LED, that displays visually recognizable information, and in some instances, can also output sounds via speakers.

An antenna control unit 106 and antenna 107 are used for wireless communication. An operation unit 108 enables a user to perform various kinds of input operations and the like to operate the communication apparatus 101. A timer unit 109 detects lapses of time.

A functional unit 110 is hardware enabling the communication apparatus 101 to execute predetermined processes. For example, when the communication apparatus 101 is the smart phone 401 or the camera 402, the functional unit 110 is an image capturing unit including an imaging element, a lens, and the like to capture still or moving images. When, for example, the communication apparatus 101 is the printer 403, the functional unit 110 is a printing unit that performs print processing.

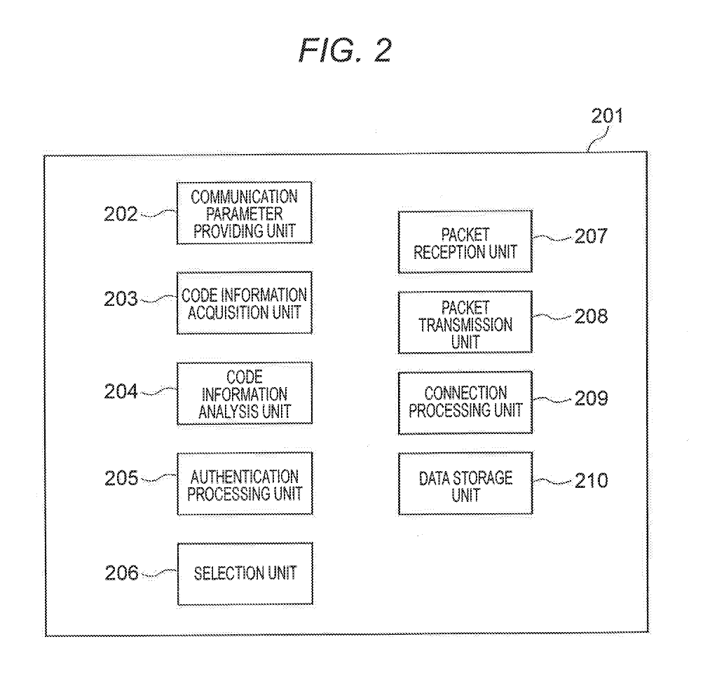

A functional configuration of the smart phone 401 will now be explained. FIG. 2 is a software functional block diagram of the smart phone 401. The software functional blocks illustrated in FIG. 2 are stored as programs in the storage unit 103, and the programs are executed by the control unit 102 to perform the functions. The control unit 102 implements the functions by controlling the hardware and computing and processing information according to the control programs. Some or all of the functional blocks can be provided via hardware. In this case, some or all of the functional blocks are, for example, implemented by an application specific integrated circuit (ASIC).

Referring to FIG. 2, reference numeral 201 represents the entire software functional blocks. A communication parameter providing unit 202 provides communication parameters in a communication-parameter setting process for setting the wireless communication parameters. The communication-parameter setting process is a process in which a providing apparatus provides the wireless communication parameters to a reception apparatus so that these apparatuses can share the communication parameters. The communication parameters include wireless communication parameters necessary for wireless LAN communication, such as a service set identifier (SSID) as a network identifier, an encryption method, a network key, an encryption key, an authentication method, or an authentication key. The communication parameters can include a MAC address, a passphrase, an IP address for performing communication in the IP layer, information necessary for higher-level services, etc. The communication parameters can include one or all of the foregoing parameters. The communication-parameter setting process can be based on Wi-Fi Protected Setupm (WPS) or Wi-Fi Direct®.

A code information acquisition unit 203 acquires an image captured by the functional unit 110 (image capturing unit) of the smart phone 401 shooting code information including a public key and the identifier of the communication apparatus for use in setting the communication parameters. The code information can be a two-dimensional code such as a CP code or a QR code® or a one-dimensional code such as a bar code.

A code information analysis unit 204 analyzes the image of the code information acquired by the code information acquisition unit 203 and acquires the encoded information. In the present embodiment, the code information can include information for use in the communication-parameter setting process. The information for use in the communication-parameter setting process is information such as a public key and the identifier of the apparatus for use in an authentication process. The public key is information used for enhancing security in the communication-parameter setting process and can be information such as a certificate or a password. In this case, the public key is an encryption key for use in a public key cryptosystem.

An authentication processing unit 205 executes an authentication process with another communication apparatus in the communication-parameter setting process. When the authentication with the other communication apparatus succeeds in the authentication process by the authentication processing unit 205, the communication parameter providing unit 202 provides the communication parameters to the other communication apparatus.

A selection unit 206 selects the activation or deactivation of a privacy protection function based on the information acquired by the code information analysis unit 204. The privacy protection function is a function in which authentication information obtained by processing the public key acquired by the code information analysis unit 204 and random information randomly set, such as a random number, by a predetermined calculation method is used in the authentication process by the authentication processing unit 205. To deactivate the privacy protection function, the random information is not used, but the authentication information obtained by processing the public key acquired by the code information analysis unit 204 by a predetermined calculation method is used in the authentication process by the authentication processing unit 205.

A packet reception unit 207 and a packet transmission unit 208 control transmission and reception of all packets, including communication protocols in upper layers. The packet reception unit 207 and the packet transmission unit 208 also control the wireless unit 104 to exchange packets, in conformity with the IEEE802.11 series standards, with another communication apparatus. A connection processing unit 209 establishes a wireless connection with another communication apparatus. A data storage unit 210 controls software and the writing and reading of various kinds of information into and from the storage unit 103.

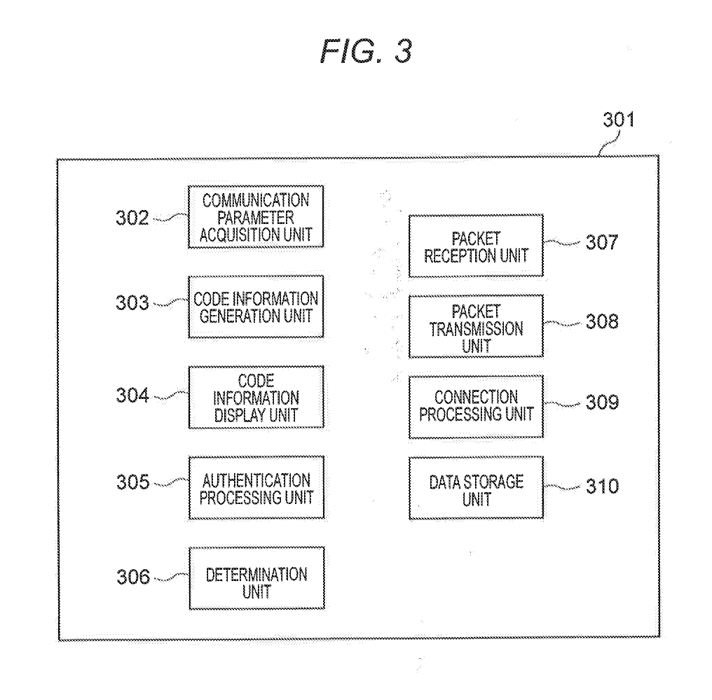

Functional configurations of the camera 402 and the printer 403 will now be explained. FIG. 3 is a software functional block diagram of the camera 402 and the printer 403. The software functional blocks illustrated in FIG. 3 are stored as programs in the storage unit 103 and the programs are executed by the control unit 102 to perform the functions. The control unit 102 implements the functions by controlling the hardware and computing and processing information according to the control programs. Some or all of the functional blocks can be provided via hardware. In this case, some or all of the functional blocks are implemented, for example, by an ASIC.

A communication parameter acquisition unit 302 receives the communication parameters from the providing apparatus in the communication-parameter setting process for setting the wireless communication parameters.

A code information generation unit 303 generates code information including information such as a public key and the identifier of the apparatus for use in setting the communication parameters. The generated code information can be dynamically generated at each execution of the communication-parameter setting process. Alternatively, the generated code information can be set at the time of shipment from the factory and the device-specific information stored in the storage unit 103 can be coded. When the static code information (fixed information) in a seal and/or label attached to the housing of the device, attached to an associated operation manual, or the like is used in the communication-parameter setting process, the camera 402 and the printer 403 may not have the code information generation unit 303. The static code information can be code information described on the shipping packaging, such as cardboard boxes or wrapping materials. The static code information can be code information set at the time of shipment from the factory or the like and is obtained by coding the device-specific information stored in the storage unit 103. The static information is fixed information that is not dynamically changed.

A code information display controller 304 displays the code information generated by the code information generation unit 303 on the display unit 105. The printer 403 can include a function of printing the code information generated by the code information generation unit 303 via the functional unit 110 (printing unit) instead of or in addition to the code information display controller 304. In this case, the printer 403 prints the code information generated by the code information generation unit 303 via the functional unit 110 (printing unit) in accordance with a user's start instruction for the communication-parameter setting process.

An authentication processing unit 305 executes an authentication process with another communication apparatus in the communication-parameter setting process. When the authentication process with the other communication apparatus succeeds in the authentication process by the authentication processing unit 205, the communication parameter acquisition unit 302 receives the communication parameters from the other communication apparatus.

A determination unit 306 determines whether to use the privacy protection function in the communication-parameter setting process. When only the code information dynamically generated by the code information generation unit 303 is to be used in the communication-parameter setting process, the camera 402 and the printer 403 do not have the determination unit 306 or use the privacy protection function at any time. In addition, when only the code information described in the operation manual or the like is to be used in the communication-parameter setting process, the camera 402 and the printer 403 do not have the determination unit 306 at any time, but use the privacy protection function.

A packet reception unit 307 and a packet transmission unit 308 control transmission and reception of all packets including the communication protocols of the higher-level layers. The packet reception unit 307 and the packet transmission unit 308 also control the wireless unit 104 to exchange packets, with another communication apparatus, in conformity with the IEEE802.11 series standards. A connection processing unit 309 establishes a wireless connection with another communication apparatus. A data storage unit 310 controls software and the writing and reading of various kinds of information into and from the storage unit 103.

Operations of the above-configured communication system of the present embodiment will now be explained. In the exemplary case described below, the smart phone 401 captures and image of the code information on the camera 402 and the printer 403 and provides the communication parameters for making a connection to the network 404 in the communication-parameter setting process based on the information included in the code information. The communication parameters provided by the smart phone 401 to the camera 402 and the printer 403 can be information for making a connection to a wireless network formed by the smart phone 401 or information for making a connection to a wireless network formed by another apparatus.

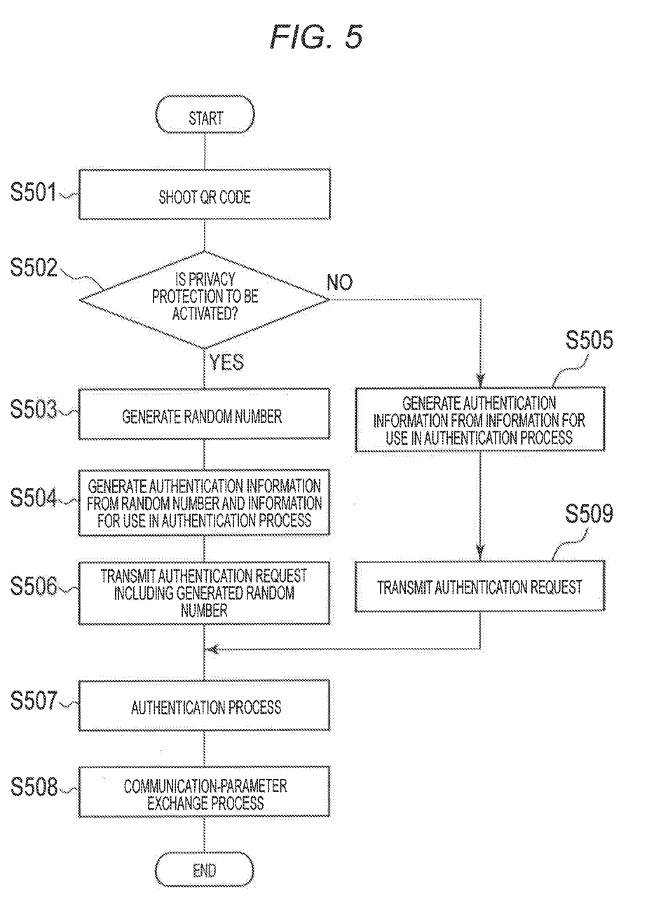

Operations of the smart phone 401 will be explained with reference to the flowchart illustrated in FIG. 5. The operations in the flowchart of FIG. 5 are implemented by the control unit 102 of the smart phone 401 executing the control program stored in the storage unit 103, calculating and processing the information, and controlling the hardware. Some or all of the steps in the flowchart of FIG. 5 can be implemented by hardware such as an ASIC.

The operations in the flowchart of FIG. 5 are started when the user, via the operation unit 108 of the smart phone 401 provides an instruction for a communication parameter setting mode to execute the communication-parameter setting process. Upon receipt of the instruction for the communication parameter setting mode, the smart phone 401 starts the functional unit 110 (image capturing unit).

The smart phone 401 captures the code information using the functional unit 110 (image capturing unit) (S501) and decodes the code information based on the captured image. When the code information acquired at S501 does not include information necessary for the communication-parameter setting process, the smart phone 401 can terminate the process with an error message.

The smart phone 401 acquires the public key and the identifier of the apparatus from the code information as information for use in the authentication process as the information necessary for the communication-parameter setting process. The identifier of the apparatus can be, for example, a MAC address or an UUID.

Next, the smart phone 401 selects whether to activate the privacy protection function in the authentication process based on the information acquired at S501 (S502). In this case, the information necessary for the communication-parameter setting process includes the information on whether to activate the privacy protection function.

The information on whether to activate the privacy protection function can be information indicating whether the public key included in the code information is set dynamically or statically. When the information acquired at S501 includes an attribute indicating that the code information is set dynamically, the smart phone 401 selects the deactivation of the privacy protection function. When the information acquired at S501 includes an attribute indicating that the code information is set statically, the smart phone 401 selects the activation of the privacy protection function.

Alternatively, the information on whether to activate the privacy protection function can be information indicative of the display method for the code information. When the information acquired at S501 includes an attribute indicating that the code information is to be displayed on the display or is described in a newly printed material, the smart phone 401 selects the deactivation of the privacy protection function. When the information acquired at S501 includes an attribute indicating that the code information is described in a label attached to a housing or a product package or in an operation manual, the smart phone 401 selects the activation of the privacy protection function.

The information on whether to activate the privacy protection function can be information indicating whether the information for use in the authentication process is device-specific information. When the information acquired at S501 includes an attribute indicating that the information for use in the authentication process is not device-specific information, the smart phone 401 selects the deactivation of the privacy protection function. When the information acquired at S501 includes an attribute indicating that the information for use in the authentication process is device-specific information, the smart phone 401 selects the activation of the privacy protection function.

The information on whether to activate the privacy protection function can be information for use in the authentication process. When the information acquired at S501 includes the information on not to activate the privacy protection function, the smart phone 401 selects the deactivation of the privacy protection function. When the information acquired at S501 includes the information on activating the privacy protection function, the smart phone 401 selects the activation of the privacy protection function.

The information on whether to activate the privacy protection function can be information indicating whether the information for use in the authentication process is information by which the device corresponding to the information can be identified. When the information acquired at S501 includes an attribute indicating that the information for use in the authentication process is not device-identifiable information, the smart phone 401 selects the deactivation of the privacy protection function. When the information acquired at S501 includes an attribute indicating that the information for use in the authentication process is device-identifiable information, the smart phone 401 selects the activation of the privacy protection function.

The attributes for use in the selection at S502 can be, for example, represented by character strings in the information acquired at S501. Alternatively, the attributes can be represented by, for example, integer values or bit patterns indicative of the attributes in the information acquired at S501. In addition, the information on whether to activate the privacy protection function can be exchanged between the apparatuses via wireless communication.

When selecting the activation of the privacy protection function (S502: Yes), the smart phone 401 generates random information varying in each authentication process (S503). In this case, the random information is a random number. The generated random number can be used only for use in privacy protection, or can be identical to a random number for use in the subsequent authentication process and parameter exchange process. Alternatively, the current time information can be used instead of the random number. Still alternatively, a hash value in the time information can be used instead of the random number.

Next, the smart phone 401 generates authentication information based on the random number generated at S503 and the information for use in the authentication process obtained from the code information (S504). In this case, the code information includes the information on the public key as the information for use in the authentication process. The smart phone 401 calculates the hash value for an information sequence in which the public key and the random number are combined to obtain the authentication information. However, the authentication information is not limited to this, and can be, for example, the hash value calculated from some or all of the data in the information for use in the authentication process obtained from the code information and the random number. The hash function for use in generation of the hash value can be SHA-1, SHA-2, MD5, etc.

When selecting the deactivation of the privacy protection function (S502: No), the smart phone 401 generates the authentication information using the information for use in the authentication process obtained from the code information (S505). The code information includes the information on the public key as the information for use in the authentication process. The smart phone 401 calculates the hash value for the public key to obtain the authentication information. At the generation of the authentication information at S505, the random information generated at S503 is not used.

After generating the authentication information at S504 or S505, the smart phone 401 transmits an authentication request signal for making a request for an authentication process to another communication apparatus (S506 and S509). In this case, the authentication request signal is an Action frame defined in the IEEE802.11 series standards. However, the authentication request signal is not limited to this, and can be an extensible authentication protocol (EAP) signal or any other wireless LAN packet. The authentication request signal includes the authentication information generated at S504 or S505. The authentication request signal can be transmitted in a unicast using the identifier of the apparatus obtained from the code information.

The authentication request signal transmitted at S506 includes the random number generated at S503. The authentication request signal transmitted at S506 can include other information for use in the authentication process, such as the encryption key and the apparatus name of the smart phone 401, as well as the authentication information and the random number. The authentication request signal can also include the identifier of an algorithm indicative of the calculation method used at the time of calculating identification information. In addition, the authentication request signal transmitted at S506 can include the character string “PubkeyNonceHash” indicating that the authentication information was generated using the random number. The authentication request signal transmitted at S509 can include the character string “PubkeyHash” indicating that the authentication information was generated as a hash value without using the random number.

At S506 or S509, the authentication request signal includes an integer value or a bit pattern indicating a generation algorithm for the authentication information on whether the random number was used.

After transmitting the authentication request signal, the smart phone 401 waits for an authentication response signal as a response to the authentication request signal. Upon receipt of the authentication response signal, the smart phone 401 performs the authentication process based on the information included in the authentication response signal (S507). At S507, the smart phone 401 can, for example, perform authentication by the public key encryption method to share a common key as the identical encryption key between the two apparatuses. Alternatively, the smart phone 401 can perform authentication by determining whether there is a match between the authentication information included in the received authentication response signal and the authentication information generated at S504 or S505. The authentication in the authentication process succeeds when there is a match between the authentication information included in the received authentication request signal and the authentication information generated at S504 or S505. When the authentication process fails at S507, the smart phone 401 can re-transmit the authentication request signal or terminate the process with an error message.

When the authentication process between the smart phone 401 and the other communication apparatus succeeds, the smart phone 401 executes a process for setting the communication parameters to the other communication apparatus (S508). This is called communication-parameter exchange process.

Specifically, the other communication apparatus with which the authentication process was performed at S507 transmits a setting request signal for making a request for the communication parameters to the smart phone 401. Upon receipt of the setting request signal, the smart phone 401 transmits a response signal including the communication parameters. The communication parameters are encrypted using the common key shared in the authentication process. This enhances security at the time of providing the communication parameters.

After the completion of the provision of the communication parameters at S508, the smart phone 401 can establish a wireless network as an AP using the provided communication parameters. Alternatively, the smart phone 401 can connect to a wireless network established by the other communication apparatus using the provided communication parameters. The smart phone 401 may not necessarily connect to the network to which the communication parameters are provided, but can terminate the operation after the completion of the communication-parameter exchange process.

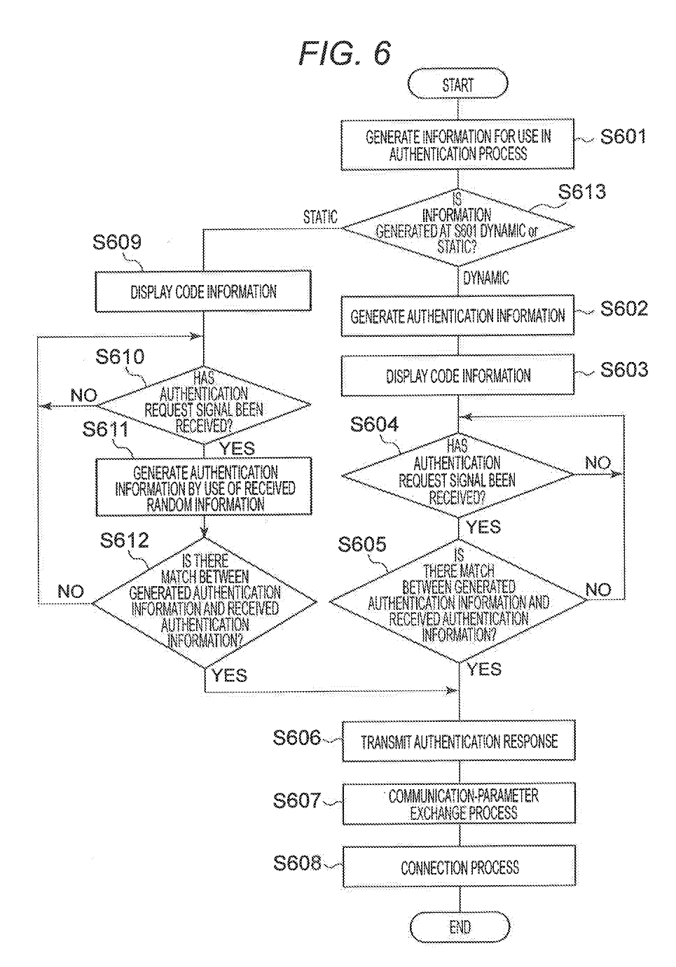

The operations of the camera 402 will now be explained with reference to the flowchart described in FIG. 6. The operations in the flowchart of FIG. 6 are implemented by the control unit 102 of the camera 402 executing the control program stored in the storage unit 103, calculating and processing the information, and controlling the hardware. Some or all of the steps in the flowchart of FIG. 6 can, for example, be implemented by hardware such as an ASIC.

The operations in the flowchart of FIG. 6 are started when the user gives an instruction for the communication parameter setting mode to execute the communication-parameter setting process by the operation unit 108 of the camera 402. Alternatively, the operations in the flowchart of FIG. 6 can be started when a predetermined signal is received or a predetermined condition, i.e., a specific time has come, the camera 402 is in a predetermined place, etc., is satisfied as a trigger.

First, the camera 402 generates the information for use in the authentication process of the communication-parameter setting process (S601). The camera 402 selects whether to set the information for use in the authentication process as dynamic information or static information (S613). That is, the camera 402 switches between the use and non-use of the privacy protection function according to the displayed code information. The camera 402 can always set the information for use in the authentication process as dynamic information and perform the communication-parameter setting process with the deactivation of the privacy protection function. In this case, the camera 402 does not execute step S613 and steps S609 to S612 described below.

When setting the information for use in the authentication process as dynamic information, that is, when not using the privacy protection function, the camera 402 generates the authentication process based on the information for use in the authentication process generated at S601 (S602). At S602, the camera 402 calculates the information for use in the authentication process by a predetermined calculation algorithm to obtain a hash value. The camera 402 does not use the random information in the calculation of the hash value at S602.

Subsequently, the camera 402 generates code information by coding information necessary for the communication-parameter setting process including the information for use in the authentication process generated at S601, and displays the same on the display unit 105 (S603). The code information displayed at S603 includes the information indicating the deactivation of the privacy protection function.

The information on whether to activate the privacy protection function can be information indicating whether the public key included in the code information was set dynamically or statically. The information on whether to activate the privacy protection function can be information indicating the display method of the code information. The information on whether to activate the privacy protection function can be information indicating whether the information for use in the authentication process is device-specific information. The information on whether to activate the privacy protection function can be information indicating whether the information for use in the authentication process is persistent information. The information on whether to activate the privacy protection function can be information indicating whether the information for use in the authentication process was set dynamically. In addition, the code information displayed at S603 can, for example, include the MAC address of the camera 402.

When the code information is displayed at S603, the camera 402 waits for receipt of an authentication request signal (S604). In this case, the authentication request signal is an Action frame defined in the 802.11 series standard. However, the authentication request signal is not limited to this, and can be an EAP signal or any other wireless LAN packet.

Upon receipt of the authentication request signal (Yes: S604), the camera 402 determines whether there is a match between the authentication information included in the received authentication request signal and the authentication information calculated at S602 (S605). When there is no match between the authentication information, that is, when the authentication has failed (S605: No), the camera 402 returns to S604 to wait for an authentication request signal again. Alternatively, the camera 402 can transmit a signal indicative of an authentication error to the smart phone 401 to terminate the process described in FIG. 6. As with the authentication request signal, the error signal can also be an Action frame or an EAP signal. When the authentication has failed, the camera 402 can provide an error indication on the display unit to bring the error condition to a user's attention. Alternatively, when the authentication has failed, the camera 402 can terminate the operation without transmitting an error signal. Still alternatively, when the authentication has failed, the camera 402 can return to S601 to generate code information again.

When setting the information for use in the authentication process as static information, that is, when using the privacy protection function, the camera 402 generates code information by coding information necessary for the communication-parameter setting process including the information for use in the authentication process generated at 5601. The camera 402 displays the generated code information on the display unit 105 (S609). The code information displayed at S609 includes the information indicating the activation of the privacy protection function. When setting the information for set in the authentication process as static information, the camera 402 sets the device-specific information of the camera 402 as the information for use in the authentication process. The device-specific information of the camera 402 is information by which the camera 402 can be identified, such as, for example, the identification information of the camera 402 or the public key of the camera 402.

When the code information is displayed at S609, the camera 402 waits for receipt of an authentication request signal (S610). Upon receipt of the authentication request signal (S604: Yes), the camera 402 calculates a hash value based on the random information included in the received authentication request signal and the information for use in the authentication process generated at S601, thereby generating the authentication information (S611). When the received authentication request signal does not include the random information, the camera 402 waits again for an authentication request signal. Alternatively, the camera 402 can transmit a signal indicative of an authentication error or terminate the process with an error message.

The camera 402 determines whether there is a match between the authentication information included in the received authentication request signal and the authentication information calculated at S611 (S612). When there is no match between the authentication information, that is, when the authentication has failed (S612: No), the camera 402 returns to S610 to wait again for an authentication request signal. Alternatively, the camera 402 can transmit a signal indicative of an authentication error to the smart phone 401 to terminate the process described in FIG. 6. As with the authentication request signal, the error signal can also be an Action frame or an EAP signal. When the authentication has failed, the camera 402 can provide an error indication on the display unit to bring the error condition to a user's attention. Alternatively, when the authentication has failed, the camera 402 can terminate the operation without transmitting an error signal. Still alternatively, when the authentication has failed, the camera 402 can return to S601 to generate code information again.

When there is a match between the authentication information received at S605 or S612 and the generated authentication information (S605 or S612: Yes), that is, when the authentication succeeds, the camera 402 transmits an authentication response signal indicating that the authentication has succeeded to the transmission source of the authentication request signal (S606). The authentication response signal includes information necessary for execution of the authentication process at the transmission source of the authentication request signal. For example, the authentication response signal includes information such as the encryption key, authentication information, public key, and random numbers.

In addition, security can be enhanced by encrypting and communicating the authentication information. The encryption can be performed using a Diffie-Hellman (DH) key sharing method, a public key cryptosystem, etc. Alternatively, the camera 402 can generate an encryption key common to the camera 402 and the other communication apparatus and use the same as a common key for use in subsequent encryption communications.

When the authentication process between the camera 402 and the other communication apparatus succeeds in such a manner as described above, the camera 402 executes the communication-parameter exchange process for acquiring and setting the communication parameters (S607).

The camera 402 transmits a setting request signal for requesting the communication parameters to the other communication apparatus with which the authentication process has been performed. Then, the camera 402 receives a response signal including the communication parameters and sets the received communication parameters. The communication parameters are encrypted using the common key shared in the authentication process. This enhances security at the provision of the communication parameters.

Upon acquisition of the communication parameters, the camera 402 connects to a wireless network using the acquired communication parameters (S608). Then, the camera 402 wirelessly communicates with the other communication apparatus.

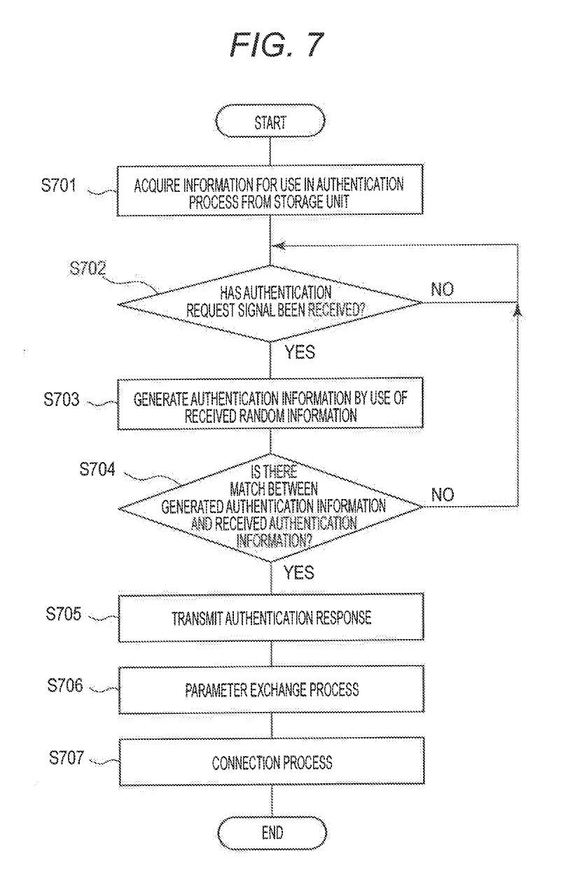

Operations of the printer 403 will now be explained with reference to the flowchart described in FIG. 7. The operations in the flowchart of FIG. 7 are implemented by the control unit 102 of the printer 403 executing the control program stored in the storage unit 103, calculating and processing the information, and controlling the hardware. Some or all of the steps in the flowchart of FIG. 7 can, for example, be implemented by hardware such as an ASIC.

The operations in the flowchart of FIG. 7 are started when the user gives an instruction for the communication parameter setting mode to execute the communication-parameter setting process by the operation unit 108 of the printer 403. Alternatively, the operations in the flowchart of FIG. 7 can be started when a predetermined signal is received or a predetermined condition, i.e., a specific time has come, the printer 403 is in a predetermined place, etc., is satisfied as a trigger. The following description is based on the assumption that the printer 403 does not have the function of dynamically changing the information for use in the authentication process. That is, the printer 403 uses the code information printed on the printer's 403 housing, documented in the printer's 403 operation manual, located on the printer's 403 packaging, etc., in the communication-parameter setting process. The information indicated by the code information is stored in the storage unit 103 of the printer 403 and is can be read and used by the control unit 102. The code information includes the information indicating that the privacy protection function is to be activated.

First, the printer 403 acquires the information for use in the authentication process from the storage unit 103 (S701). Next, the printer 403 waits for receipt of an authentication request signal (S702). Upon receipt of the authentication request signal (S702: Yes), the printer 403 generates the authentication information based on the information for use in the authentication process and the random information included in the received authentication request signal (S703). In this case, the code information printed on the housing, the operation manual, the package, etc., as described above includes the information on the public key of the printer 403 for use in the authentication process. The printer 403 acquires the authentication information by calculating a hash value for an information sequence in which the public key and the random information, such as a random number, are combined.

The printer 403 then determines whether there is a match between the authentication information included in the received authentication request signal and the authentication information generated at S703 (S704). When there is no match between the authentication information, that is, when the authentication has failed (S704: No), the printer 403 returns to S702 to wait again for an authentication request signal. Alternatively, the printer 403 can transmit a signal indicative of an authentication error and terminate the process described in FIG. 7. As with the authentication request signal, the error signal can be an Action frame or an EAP signal.

When it is determined at 5704 that there is a match between the authentication information included in the received authentication request signal and the authentication information generated at 5703, that is, when the authentication has succeeded (S704: Yes), the printer 403 transmits an authentication response signal indicating that the authentication has succeeded (S705). Step S705 and subsequent steps are the same as steps S606 to S608 described in FIG. 6, and therefore, descriptions thereof will be omitted.

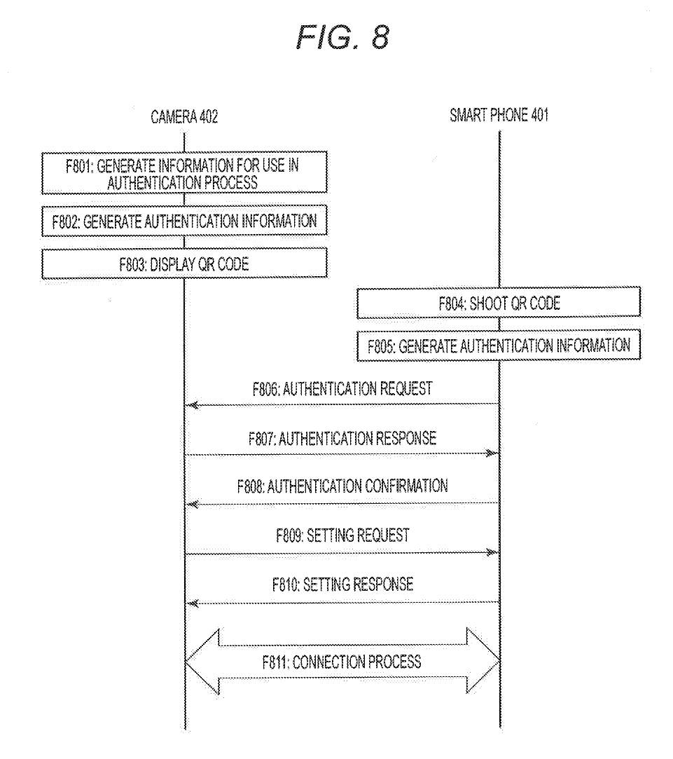

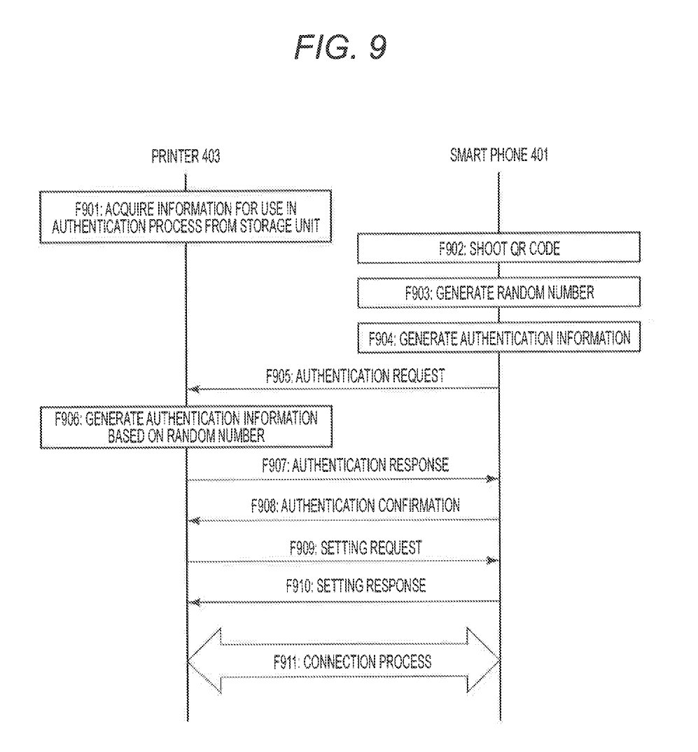

Operations of the communication system of the present embodiment will be explained with reference to the sequence charts in FIGS. 8 and 9. FIG. 8 is a sequence chart in which the camera 402 acquires the communication parameters from the smart phone 401. The sequence in which the camera 402 deactivates the privacy protection function will be explained with reference to FIG. 8.

The camera 402 generates the information for use in the authentication process (F801). Next, the camera 402 generates the authentication information based on the generated information for use in the authentication process (F802). Then, the camera 402 generates a QR code® based on the information for use in the authentication process, and displays the same on the display unit 105 (F803). The smart phone 401 captures the QR code® of the camera 402 to acquire the information for use in the authentication process (F804).

The smart phone 401 determines that the privacy protection function is not to be activated based on the information included in the QR code®, and calculates the authentication information based on the information for use in the authentication process without using a random number (F805). Then, the smart phone 401 transmits an authentication request signal including the calculated authentication information to the camera 402 (F806).

Upon receipt of the authentication request signal, the camera 402 performs the authentication process based on the authentication information calculated by the camera 402 and the authentication information included in the received authentication request signal. When the authentication succeeds, the camera 402 transmits an authentication response signal including the information on the encryption key to the smart phone 401 (F807).

The smart phone 401 receives the authentication response signal and executes the authentication process based on the information included in the signal. When the authentication succeeds, the smart phone 401 transmits an authentication confirmation signal to the communication apparatus (F808) to notify the camera 402 that the authentication has succeeded.

Upon receipt of the authentication confirmation signal, the camera 402 transmits a setting request signal for making a request for the communication parameters to the smart phone 401 (F809). Upon receipt of the setting request signal, the smart phone 401 transmits a setting response signal including the communication parameters to the camera 402 (F810). In this case, the smart phone 401 can encrypt the communication parameters using the common encryption key shared in the authentication process.

Upon receipt of the communication parameters, the camera 402 connects to a wireless network established by the smart phone 401 (F811). Upon completion of the connection, the camera 402 can perform data communications with the smart phone 401 on the wireless network.

FIG. 9 is a sequence chart in which the printer 403 acquires the communication parameters from the smart phone 401.

First, the printer 403 acquires the information for use in the authentication process from the storage unit (F901). The smart phone 401 captures the QR code® described included on the printer's 403 housing, the printer's 403 packaging, the printer's 403 operation manual to acquire the information for use in the authentication process (F902). The smart phone 401 determines the activation of the privacy protection function based on the information included in the QR code®, and generates a random number (F903). Then, the smart phone 401 generates the authentication information based on the information for use in the authentication process acquired from the QR code® and the random number (F904). Then, the smart phone 401 transmits the authentication request signal including the generated identification information and the random number to the printer 403 (F905).

Upon receipt of the authentication request signal, the printer 403 generates the authentication information based on the information for use in the authentication process stored in the storage unit and the random number included in the authentication request (F906). Then, the printer 403 performs the authentication process based on the generated identification information and the authentication information included in the received authentication request signal. When the authentication succeeds, the printer 403 transmits the authentication response signal including the information on the encryption key generated in the authentication process to the smart phone 401 (F907). The printer 403 then performs the same steps as F808 to F811 with the smart phone 401, and the printer 403 and the smart phone 401 start communication (F908 to F911).

As described above, according to the present embodiment, when the dynamically set information is not used to set the communication parameters, the random information is used to generate provisional authentication information not specific to the device. Therefore, the device-specific information is not wirelessly transmitted to protect privacy.

When the dynamically set information is used to set the communication parameters, the authentication information is generated without using the random information and the information included in the authentication request signal, it is possible to reduce the time taken for the authentication process and the processing load while protecting privacy. In addition, when the dynamically set information is used to set the communication parameters, there is no need to generate the authentication information at each receipt of the authentication request signal, and it is possible to reduce the time taken for the authentication process and the processing load.

### Modification Example

In the foregoing description, the method of acquiring the information necessary for the communication-parameter setting process using the code information, such as a QR code®, has been explained. However, the information necessary for the communication-parameter setting process can be exchanged via wireless communication using a wireless LAN in the IEEE802.11 series, NFC, or Bluetooth®.

Operations of the smart phone 401 when the information necessary for the communication-parameter setting process is exchanged via wireless communication will now be explained. When the communication-parameter setting process is started, the smart phone 401 transmits a transmission request signal for making a request for transmission of the information for use in the authentication process. In this case, the transmission request signal is an Action frame defined in the 802.11 series standard. However, the transmission request signal is not limited to this, and can be an EAP signal or any other wireless LAN packet. The request signal can be encrypted in advance by the encryption key shared between the smart phone 401 and the other communication apparatus. For example, the character string representing the encryption key displayed on the display unit of the other communication apparatus can be input via the operation unit 108 of the smart phone 401 to share the encryption key between the apparatuses.

Next, the smart phone 401 waits for a response signal to the request signal. The response signal includes the information for use in the authentication process. The information for use in the authentication process can, for example, include the public key. The response signal can also include information other than the information for use in the authentication process. For example, the response signal can include information on whether to activate the privacy protection function. The information for use in the authentication process can be encrypted by the same encryption key as that used for encryption of the request signal or another encryption key.

Upon receipt of the response signal, the smart phone 401 determines whether to activate the privacy protection function. For example, the smart phone 401 can determine whether to activate the privacy protection function based on the information included in the received response signal. The subsequent steps are the same as step S502 and subsequent steps.

Operations of the camera 402 and the printer 403 as receiving apparatuses to receive the communication parameters when the information necessary for the communication-parameter setting process is exchanged via wireless communication will now be explained. The receiving apparatus, i.e., the camera 402 or the printer 403 waits for a request signal wirelessly transmitted from the smart phone 401. The receiving apparatus can display the character string indicative of the encryption key for use in the encryption of the request signal on the display unit 105 prior to waiting for the request signal.

Upon receipt of the request signal, the receiving apparatus wirelessly transmits a response signal to the smart phone 401. The response signal includes the information for use in the authentication process. The information for use in the authentication process can, for example, include the public key. The request signal can also include the information on whether to activate the privacy protection function. The information can be represented in the form of integer value, bit pattern, or character string. The transmission response signal can include information other than the foregoing information. The information for use in the authentication process can be encrypted by the same encryption key as that used for decoding the request signal or another encryption key.

Upon receipt of the request signal, the receiving apparatus waits for receipt of an authentication request signal from the smart phone 401. The subsequent steps are the same as the steps S604 to S608 or S702 to S707 described in FIG. 6, and therefore, descriptions thereof will be omitted.

As described above, the information necessary for the communication-parameter setting process can be provided by using communication in the IEEE802.11 series standard instead of by capturing a QR code® including the code information. In such a case, the device-specific information can be encrypted before exchanged to protect privacy.

In the foregoing embodiment, the information necessary for the communication-parameter setting process can be exchanged using communication based on NFC, Bluetooth®, ZigBee, or TransferJet®. For example, the information necessary for the communication-parameter setting process can be exchanged via NFC, and the communication parameters can be provided via communication in conformity with the IEEE802.11 series standard.

In the case of exchanging the information necessary for the communication-parameter setting process via NFC, when an NFC interface is implemented by an autonomously rewritable tag or in a bidirectional communication mode, the information for use in the authentication process can be treated as dynamically generable information. When the NFC interface is an autonomously non-rewritable tag, the information for use in the authentication process can be treated as dynamically non-generable information.

When the information necessary for the communication-parameter setting process can be exchanged by a plurality of methods, the smart phone 401 can determine whether to activate the privacy protection function depending on the kind of the method used in acquisition of the information necessary for the communication-parameter setting process. For example, when acquiring the information for use in the authentication process by capturing the code information or NFC, the smart phone 401 can always activate the privacy protection function. When acquiring the information for use in the authentication process via the IEEE802.11 series standard or Bluetooth®, the smart phone 401 can always determine the deactivation of the privacy protection function.

According to the foregoing description, compatibility, in setting the communication parameters, can be established between the protection of privacy and the prevention of unnecessary increase in the time taken for the authentication or unnecessary increase in the processing load.

Embodiments can also be implemented by supplying a program for performing one or more of the above-described functions to a system or an apparatus via a network or a storage medium, and one or more processors in a computer of the system or the apparatus reading and executing the program. In addition, embodiments can be implemented by a circuit performing one or more functions, e.g., an ASIC.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-007426, filed Jan. 18, 2016, which is hereby incorporated by reference herein in its entirety.

What is claimed is:

1. A communication apparatus comprising:
an acquisition unit configured to acquire information for setting wireless communication parameters;
a first generation unit configured to generate authentication information using random information randomly set and information for use in an authentication process included in the acquired information;
a second generation unit configured to generate authentication information using the information for use in the authentication process included in the acquired information and without using the random information;
an authentication unit configured to, when the acquired information includes predetermined information indicating that the authentication process is to be performed using the authentication information generated using the random information, perform the authentication process involving wireless communication of the authentication information generated by the first generation unit with another communication apparatus, and when the acquired information does not include the predetermined information, perform the authentication process involving wireless communication of the authentication information generated by the second generation unit with the another communication apparatus; and
a setting unit configured to, when authentication succeeds, set the wireless communication parameters to the another communication apparatus with which the wireless communication was performed in the authentication process.

2. The communication apparatus according to claim 1, wherein the predetermined information is information indicating that the acquired information includes identification information of the another communication apparatus.

3. The communication apparatus according to claim 1, wherein the predetermined information is information indicating that the acquired information is fixed information.

4. The communication apparatus according to claim 1, wherein the predetermined information is information indicating that the acquired information is device-specific information.

5. The communication apparatus according to claim 1, wherein the acquisition unit acquires the information from a captured image of code information.

6. The communication apparatus according to claim 1, wherein, when the acquisition unit acquires the information from a captured image of code information described in a label attached to the communication apparatus, contained in an operation manual, or attached to packaging associated with the communication apparatus, the authentication unit performs the authentication process using the authentication information generated by the first generation unit.

7. The communication apparatus according to claim 1, wherein, when the acquisition unit acquires the information from a captured image of code information displayed on a display, the authentication unit performs the authentication process using the authentication information generated by the second generation unit.

8. The communication apparatus according to claim 1, wherein the authentication information generated by the first generation unit is a hash value calculated from the acquired information and the random information.

9. The communication apparatus according to claim 1, wherein the authentication information generated by the second generation unit is a hash value calculated from the acquired information without using the random information.

10. The communication apparatus according to claim 1, wherein the first generation unit generates the authentication information based on a public key acquired by the acquisition unit and the random information, and
the second generation unit generates the authentication information based on the public key acquired by the acquisition unit without using the random information.

11. The communication apparatus according to claim 1, wherein the random information is a random number.

12. The communication apparatus according to claim 1, wherein the communication parameters include at least one of an SSID, an encryption key, an encryption method, a network key, an authentication key, or authentication method.

13. The communication apparatus according to claim 1, wherein the communication parameters are information for performing communication in conformity with IEEE802.11 series standards.

14. The communication apparatus according to claim 1, wherein, when the authentication information generated by the first generation unit is wirelessly communicated in the authentication process, the random information used for generation of the authentication information by the first generation unit is transmitted to the another communication apparatus.

15. The communication apparatus according to claim 1, wherein the authentication succeeds when there is a match between the authentication information transmitted to the another communication apparatus and the authentication information received from the another communication apparatus in the authentication process.

16. A communication apparatus comprising:
a display control unit configured to display information for setting wireless communication parameters and predetermined information indicating whether an authentication process is to be performed using authentication information generated using random information;
an authentication unit configured to perform, based on the displayed information, an authentication process involving wireless communication of the authentication information with another communication apparatus; and
a setting unit configured to, when the authentication succeeds, set communication parameters received from the another communication apparatus with which the wireless communication was performed in the authentication process.

17. The communication apparatus according to claim 16, further comprising a first generation unit configured to generate authentication information using random information and information for use in an authentication process included in the displayed information, wherein
when the displayed predetermined information indicates that the authentication process is to be performed using the authentication information generated using the random information, the authentication unit performs the authentication process using the authentication information generated by the first generation unit.

18. The communication apparatus according to claim 17, wherein the random information is received from the another communication apparatus.

19. The communication apparatus according to claim 16, further comprising a second generation unit configured to generate authentication information using the information for use in the authentication process included in the displayed information displayed and without the random information, wherein
when the displayed predetermined information indicates that the authentication process is not to be performed using the authentication information generated using the random information, the authentication unit performs the authentication process using the authentication information generated by the second generation unit.

20. A method of sharing wireless communication parameters comprising:
acquiring information for setting wireless communication parameters;
generating authentication information using random information randomly set and information for use in an authentication process included in the acquired information;
generating authentication information using the information for use in the authentication process included in the acquired information and without using the random information;
performing, when the acquired information includes predetermined information indicating that the authentication process is to be performed using the authentication information generated using the random information, the authentication process involving wireless communication of the authentication information generated using the random information with another communication apparatus;
performing, when the acquired information does not include the predetermined information, the authentication process involving wireless communication of the authentication information generated without using the random information with the another communication apparatus; and
setting, when authentication succeeds, the wireless communication parameters to the another communication apparatus with which the wireless communication was performed in the authentication process.

21. A method of sharing wireless communication parameters comprising:
displaying information for setting wireless communication parameters and predetermined information indicating whether an authentication process is to be performed using authentication information generated using random information;
performing, based on the displayed information, an authentication process involving wireless communication of the authentication information with another communication apparatus; and
setting, when the authentication succeeds, communication parameters received from the another communication apparatus with which the wireless communication was performed in the authentication process.

22. A computer readable storage medium storing computer executable instructions for causing a computer to execute a method of sharing wireless communication parameters, the method comprising:
acquiring information for setting wireless communication parameters;
generating authentication information using random information randomly set and information for use in an authentication process included in the acquired information;
generating authentication information using the information for use in the authentication process included in the acquired information and without using the random information;
performing, when the acquired information includes predetermined information indicating that the authentication process is to be performed using the authentication information generated using the random information, the authentication process involving wireless communication of the authentication information generated using the random information with another communication apparatus;
performing, when the acquired information does not include the predetermined information, the authentication process involving wireless communication of the authentication information generated without using the random information with the another communication apparatus; and
setting, when authentication succeeds, the wireless communication parameters to the another communication apparatus with which the wireless communication was performed in the authentication process.

23. A computer readable storage medium storing computer executable instructions for causing a computer to execute a method of sharing wireless communication parameters, the method comprising:
displaying information for setting wireless communication parameters and predetermined information indicating whether an authentication process is to be performed using authentication information generated using random information;
performing, based on the displayed information, an authentication process involving wireless communication of the authentication information with another communication apparatus; and
setting, when the authentication succeeds, communication parameters received from the another communication apparatus with which the wireless communication was performed in the authentication process.
